(19) United States
(12) Patent Application Publication
(10) Pub. No.: US 2011/0249353 A1
(43) Pub. Date: Oct. 13, 2011

(54) Intentionally Buckled Columns and Columns with Displacement Controls that Form Optical Shapes

(76) Inventor: David WHITE, Denver, CO (US)

(21) Appl. No.: 13/082,021

(22) Filed: Apr. 7, 2011

Related U.S. Application Data
(60) Provisional application No. 61/322,413, filed on Apr. 9, 2010.

(51) Int. Cl. G02B 7/185; B23P 11/00; B32B 1/08; B23P 17/04; G02B 7/182; B32B 3/00

(52) U.S. Cl. 359/846; 359/871; 428/156; 428/34.1; 29/592; 29/428

(57) ABSTRACT

Described herein are buckled structures useful for forming specific and precise optical shapes. For example, buckled structures are disclosed which have parabolic, near-parabolic, cylindrical, near cylindrical, conic section shapes, arcs and other non-sinusoidal optical curves. Also described herein are buckled structures including one or more restraints for forcing the structures to adopt or maintain specific optical shapes upon or after buckling. In another aspect, provided herein are methods for forming optical structures.

### CROSS REFERENCE TO RELATED APPLICATION

This application claims the benefit of and priority under 35 U.S.C. 119(e) to U.S. Provisional Application 61/322,413 filed on Apr. 9, 2010, which is hereby incorporated by reference in its entirety.

### BACKGROUND OF THE INVENTION

This invention is in the field of compressed buckled structures. This invention relates generally to buckling of columns or beams to form optical shaped panels for use in solar concentrating applications.

A column or beam typically assumes a sinusoidal (Euler) shape of the first or higher harmonic order contour when a buckling force is applied. The typical column deflection in response to an end force applied in the longitudinal direction of a column is described by the formula y=k sin(Nπ/L), where y is the deflection, N is an integer, L is the column length and k is a constant. This formula is valid for rounded-end constraints and constant area and material properties along the column length. For the lowest harmonic (N=1), the shape is a half sign wave. The buckled column normally only forms sinusoidal shapes and cannot form parabolic shapes. As the end forces increase, the deflection changes from a half sine wave to multiple sign waves. There is no force that will produce a parabolic shape. FIG. 1 illustrates a parabolic curve 101, an N=1 sinusoidal curve 102 and an N=3 sinusoidal curve 103.

International Patent Application Publication WO 80/02604 discloses a solar radiation reflector having a trough shape. A reflective sheet is buckled to form a cylindrical elastic concave shape for collection and focusing of solar radiation. The shape formed by the buckled sheet is non-parabolic and inelastic deformations to the sheet are utilized to optimize the focusing of reflected radiation.

U.S. Pat. No. 4,571,812 discloses a flexible reflective sheet having an initial radius of curvature which is buckled into a substantially parabolic configuration. Also disclosed is the buckling of initially curved reinforcing ribs into substantially parabolic configurations.

U.S. Pat. No. 5,398,462 discloses a method for inhibiting buckling of a beam loaded in compression. Guy wires and virtual braces are used in a feedback mechanism to maintain the beam in an unbuckled configuration.

### SUMMARY OF THE INVENTION

Described herein are buckled structures useful for forming specific and precise optical shapes. For example, buckled structures are disclosed which have parabolic, near-parabolic, cylindrical, near cylindrical, conic arcs and other non-sinusoidal optical curves. Also described herein are buckled structures including one or more restraints for forcing the structures to adopt or maintain specific optical shapes upon or after buckling. In another aspect, provided herein are methods for forming optical structures. Generally, the buckled structures provided herein are elastically buckled columns and/or beams having uncurved initial states; that is, they do not undergo inelastic deformations to impart an initial curvature before buckling.

In one aspect, an optical structure comprises a buckled beam having an optical shape. In a specific embodiment of this aspect, an area moment of inertia of the beam varies along a length of the beam. For example, the area moment of inertia may be selected and/or preselected so as to give the beam the optical shape when buckled. In general, the varying area moment of inertia is a second moment of inertia about a transverse axis or transverse axes of the beam.

For certain embodiments, a cross sectional area of the beam varies along the length of the beam. For some embodiments, a material property of the beam varies along the length of the beam, for example the density, material composition, crystal structure, structural composition, reticulation, extent of cross-linking (e.g., in a polymer), elastic modulus and any combination of these. In one aspect a cross-sectional area and/or a material property of the beam is selected so as to give the beam the optical shape when buckled.

In specific embodiments, the beam comprises a hollow tube having a thickness which varies along the length of the beam. In certain embodiments, the beam comprises a hollow tube which has a varying deformation along the length of the beam, for example a hollow tube having a circular cross-sectional shape at the ends of the beam and a non-circular cross-sectional shape at a central longitudinal position of the beam. In embodiments, the beam comprises a column having a plurality of segments where, for example, the area moments of inertia of adjacent segments are different.

When buckled, such beams form a precise optical shape, for example useful for defining an optical shape of an attached or unitary flexible sheet. An optical structure of some embodiments further comprises a flexible sheet attached to the beam. In such embodiments, the flexible sheet is separate from the beam or is monolithic with the beam. In certain embodiments, the flexible sheet is a reflective sheet. For example, a reflective sheet comprises a reflective film or highly polished or anodized metal surface. In an embodiment comprising a beam and flexible sheet of a unitary body, the beam is formed by rolling a portion of a flexible sheet over onto itself to form a rolled edge. Preferably, a surface of the flexible sheet has an optical shape after the attached or monolithic beam is buckled.

For some embodiments, an optical structure further comprises one or more restraints attached to the buckled beam to maintain the optical shape of the beam. For example, at least one of the restraints may be attached to a supporting structure. In certain embodiments, one or more restraints are attached to a beam which forms an optical shape when buckled, for example a parabolic or other non-sinusoidal shape. For example, the positions and/or the tension in the one or more restraints are selected so as to give the beam a specific optical shape when buckled. For example, at least one of the restraints provides a force to the beam such that the beam adopts an optical shape when buckled.

In another aspect, provided herein are methods for forming optical structures. A method of this aspect comprises the steps of: providing a beam and applying a force to one or both ends of the beam to buckle the beam. In a specific embodiment, the applying step buckles the beam into an optical shape.

As described above, useful beams include those beams having an area moment of inertia which varies along a length of the beam, for example an area moment of inertia about a transverse axis or transverse axes of the beam. In a specific embodiment, a cross sectional area of the beam varies along the length of the beam. Optionally, a material property of the beam varies along the length of the beam, for example the density and/or composition.

Another method of this aspect further comprises the step of attaching one or more restraints to the beam. In certain embodiments, the one or more restraints maintain an optical shape of the beam. In some embodiments, the one or more restraints give the beam an optical shape when buckled.

A specific method of this aspect comprises the steps of: providing a beam; attaching one or more restraints to the beam; and applying a force to one or both ends of the beam to buckle the beam. In one embodiment, the applying step buckles the beam into an optical shape. In another embodiment, the attaching step forces the beam into an optical shape.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 illustrates the differences between sinusoidal and parabolic shapes.

FIG. 2 illustrates buckling of a beam by application of a force.

FIG. 3 illustrates an exemplary buckled beam.

FIG. 4 illustrates an exemplary buckled beam.

FIGS. 5 and 6 illustrate segmented buckled beam embodiments.

FIGS. 7A and 7B illustrate exemplary optical structures.

FIG. 8 illustrates a buckled beam and attached flexible sheet.

FIG. 9 provides an overview of a first method for forming an optical structure.

FIG. 10 provides an overview of a second method for forming an optical structure.

FIG. 11 provides an overview of a third method for forming a optical structure.

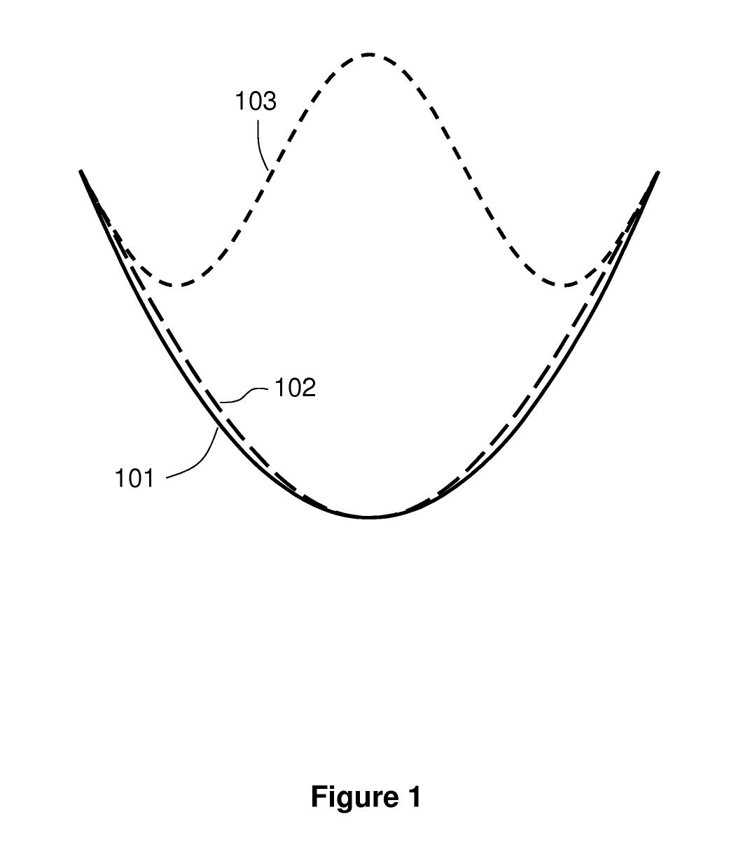

### DETAILED DESCRIPTION OF THE INVENTION

In general the terms and phrases used herein have their art-recognized meaning, which can be found by reference to standard texts, journal references and contexts known to those skilled in the art. The following definitions are provided to clarify their specific use in the context of the invention.

“Buckled beam” refers to a column or beam which has undergone an elastic deformation due to application of a compressive load or force.

“Optical shape” refers to a non-sinusoidal curved shape. In a specific embodiment, a buckled beam having an optical shape is a beam which, when buckled, has one or more curved surfaces. Optical shapes include, but are not limited to: parabolic shapes, cylindrical shapes, conic section shapes, arc shapes, focusing shapes (e.g., shapes having one or more focal points) and other non-sinusoidal shapes.

“Parabolic” refers to a shape characteristic of a parabola. In one embodiment, a parabolic shape refers to a conic section having a single focal point. In the specific application of a parabolic reflector, incoming rays parallel to the line between the focus and the vertex of the parabola are reflected to the focus of the parabola.

“Area moment of inertia” refers to a property of an object describing a distribution of the area of the object about an axis or axes. The terms “area moment of inertia,” “second moment of inertia” and “second moment of area” are used synonymously herein. In certain embodiments, the area moment of inertia of an object refers to the area moment of inertia of the object perpendicular to a longitudinal axis of the object. For a beam or column having a longitudinal axis, a specific area moment of inertia is in reference to axes perpendicular to the longitudinal axis of the beam or column.

“Restraint” refers to an object used to hold another object in place. A restraint also refers to an object used to apply a force or load to another object, or an object used to force another object to adopt a specific shape. In one embodiment, a restraint refers to an object attached to a beam or column which alters the shape of the beam or column when buckled. In one embodiment, a restraint refers to an object attached to a beam or column which allows the beam or column to maintain a buckled shape.

“Supporting structure” or “support structure” refers to a rigid device used for supporting another object, transferring the weight of the object to the ground, and/or holding or controlling the position of the object. In an embodiment, a supporting structure is comprised of a plurality of rigid members.

“Reflective sheet” refers to a sheet, panel, or film having a highly reflective surface for reflection of incident light. In an embodiment, a reflective sheet comprises a thin sheet of material, for example a metal sheet, preferably aluminum or steel, with a reflective film thereon having a reflectivity acceptable for use in solar collectors (e.g., ReflecTech™ silvered film). In an embodiment, a reflective sheet comprises a metal sheet having a polished or anodized surface. In an embodiment, a reflective sheet comprises a reflective film.

“Unitary”, “unitary body” and “monolithic” refer to objects or elements of a single body of the same material.

The methods and devices described herein are useful in some aspects for forming parabolic structures useful as parabolic solar concentrators. Certain embodiments of the methods and devices described herein reduce the amount of material and manufacturing process complexity required to create a precise and accurate optical shape, resulting in lighter, stronger and higher performing optical structures. An advantage of a number of buckled beam embodiments described herein includes formation of precise and/or accurate optical (e.g., parabolic) shapes even when manufacturing tolerances of the beam in the unbuckled state are lower than the maximum attainable tolerances.

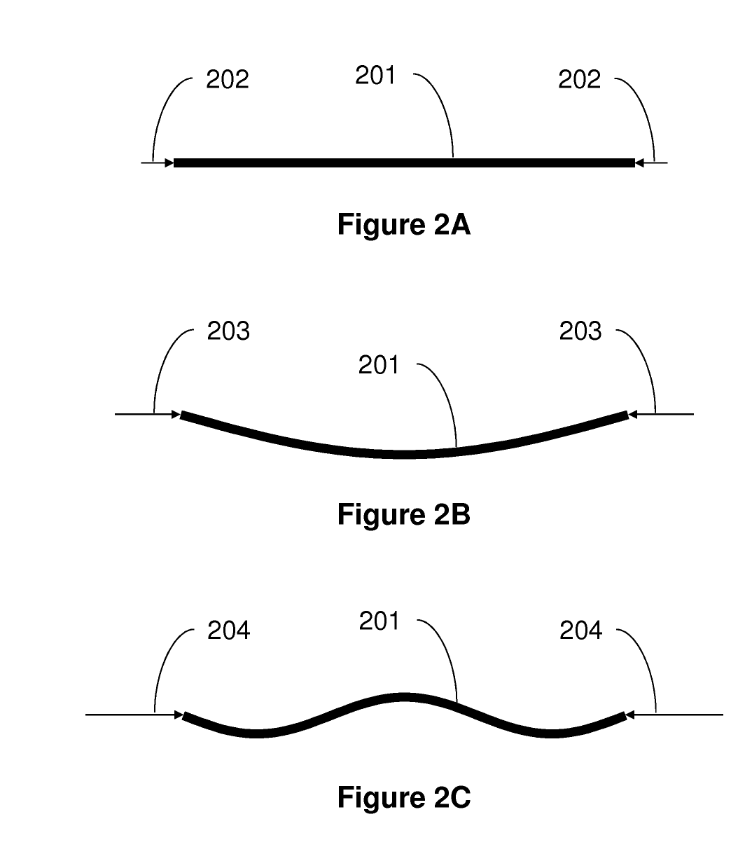

FIGS. 2A, 2B and 2C illustrate the buckling of a beam by application of a force. Initially, beam 201 is straight, as shown in FIG. 2A. As forces 202 are applied and surpass the buckling strength of the beam, beam 201 buckles into the first order sinusoidal shape as shown in FIG. 2B. Such a beam cannot form a parabolic shape by application of an increased buckling force 203. As force 204 is increased, the shape of the buckled beam 201 becomes that of a higher order sinusoidal shape, as shown in FIG. 2C.

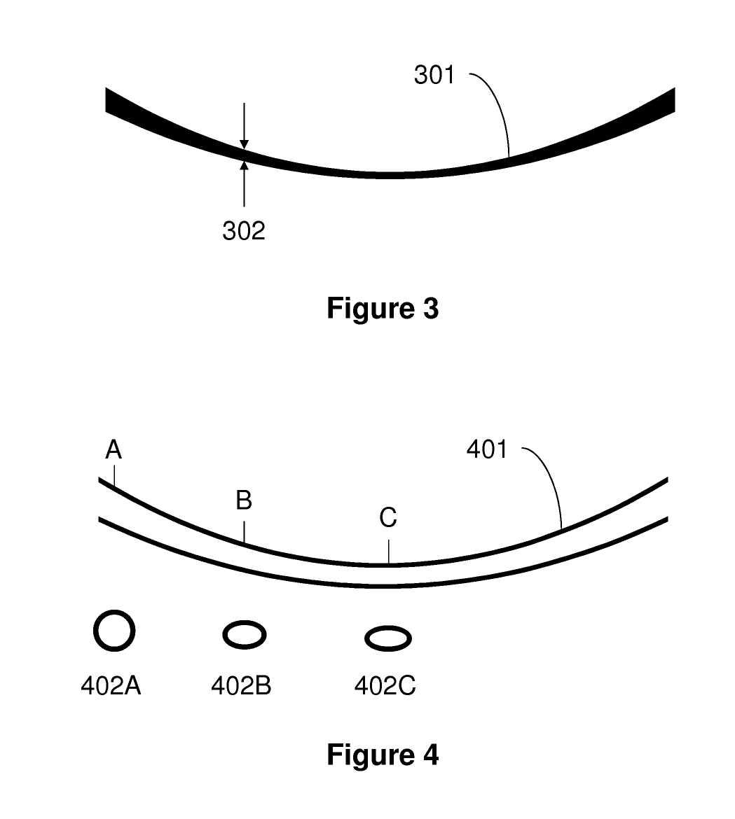

In one embodiment, formation of a parabolic buckled structure requires a beam which has an area moment of inertia which varies along the length of the beam. As used herein, “an area moment of inertia which varies along the length of the beam” refers to the area moment of inertia of the beam perpendicular to a longitudinal axis of the beam which varies along a longitudinal axis of the beam. FIGS. 3 and 4 illustrate exemplary buckled beams 301 and 401 which have area moments of inertia which vary along the lengths of the beams. In a first embodiment, shown in FIG. 3, beam 301 has a thickness 302 which varies continuously along the length of the beam. In a second embodiment, shown in FIG. 4, beam 401 comprises a hollow tube having a uniform wall thickness but which has a cross section 402A, 402B, 402C which varies continuously along its length. In a specific embodiment, a hollow tube having a cross sectional area which varies along its length can be formed by providing a hollow tube of uniform cross section, and deforming the cross section (e.g., by bending or roll forming) at one or more points along the length of the tube. In some embodiments a parabolic buckled beam comprises a hollow tube having a wall thickness which varies continuously along a length of the tube and/or a beam which has a cross-sectional area which varies continuously along a length of the beam.

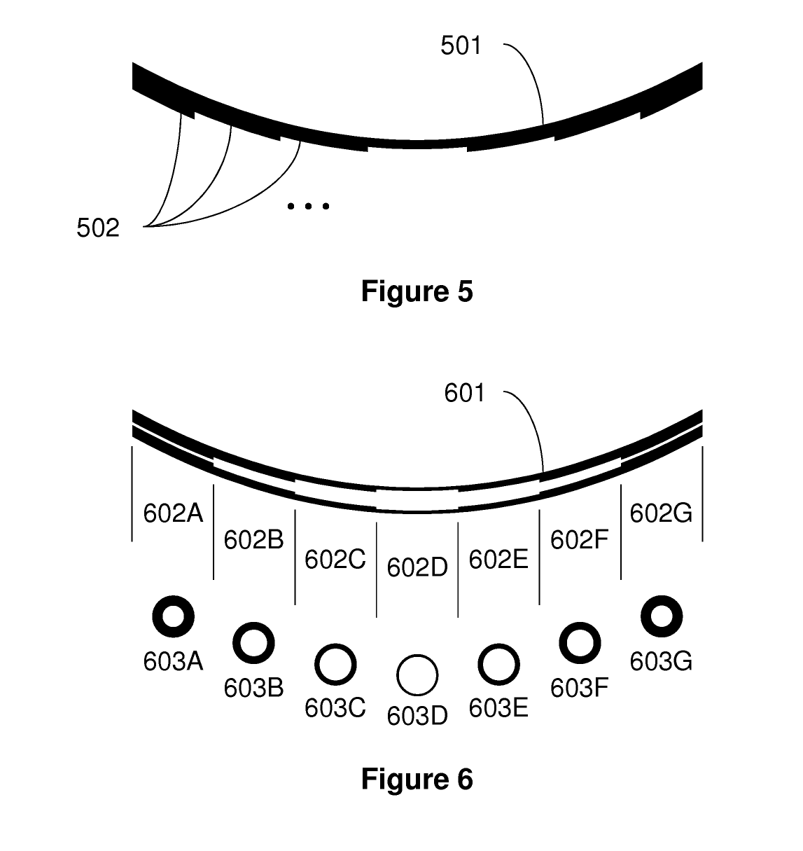

In some embodiments, a parabolic buckled beam comprises a beam having multiple segments. FIG. 5 illustrates a parabolic buckled structure embodiment comprising beam 501 having multiple segments 502 of varying cross sectional area, each segment having a constant cross sectional area across the segment length.

FIG. 6 illustrates another parabolic buckled structure comprising beam 601 having multiple segments 602A-602G of varying wall thickness 603A-603G, each segment having a constant wall thickness across the segment length.

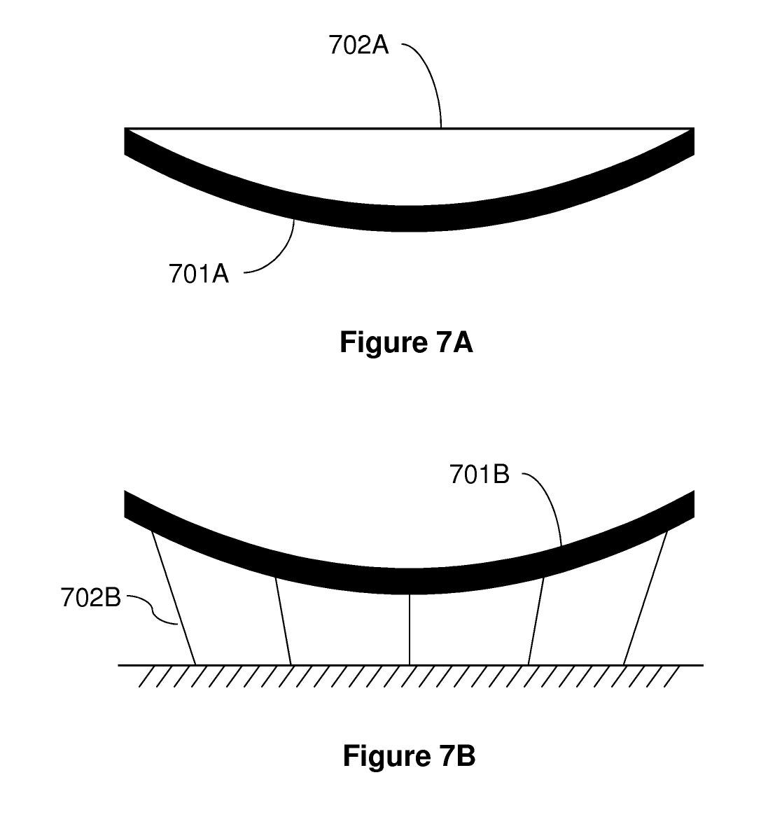

FIGS. 7A and 7B illustrate exemplary parabolic structure embodiments. In FIG. 7A, restraint 702A is attached to beam 701A after buckling to maintain the parabolic shape of beam 701A. In FIG. 7B, restraints 702B are attached to beam 701B before buckling to force beam 701B to a parabolic shape when buckled. In certain embodiments, use of one or more restraints suppresses higher order harmonic buckled configurations, for example restraints at the ends or interior positions of the buckled beam. In embodiments, the restraints are attached to other parts of the buckled beam, a supporting structure, the ground, or another fixed object.

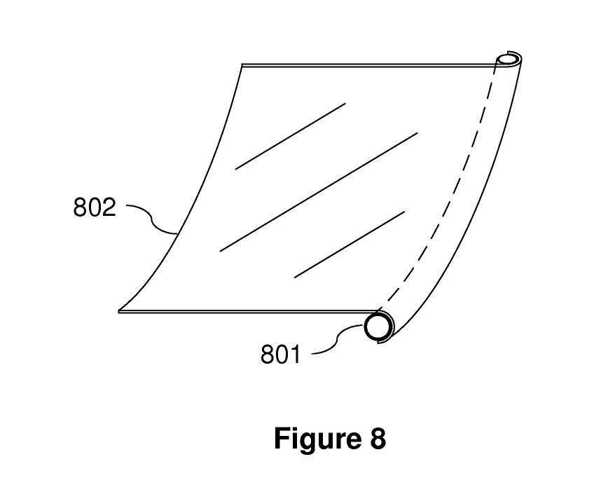

FIG. 8 illustrates an exemplary parabolic structure comprising a buckled beam 801 and a sheet 802 attached to buckled beam 801. In this embodiment, buckled beam 801 comprises a hollow tube, which, when buckled, forces sheet 802 to adopt a parabolic shape. In this embodiment, an edge of sheet 802 wraps around a portion of the hollow tube of buckled beam 801 to allow sheet 802 to be retained. A second buckled beam (not shown) can be used to retain a second edge of sheet 802. In exemplary embodiments, sheet 802 is a reflective sheet.

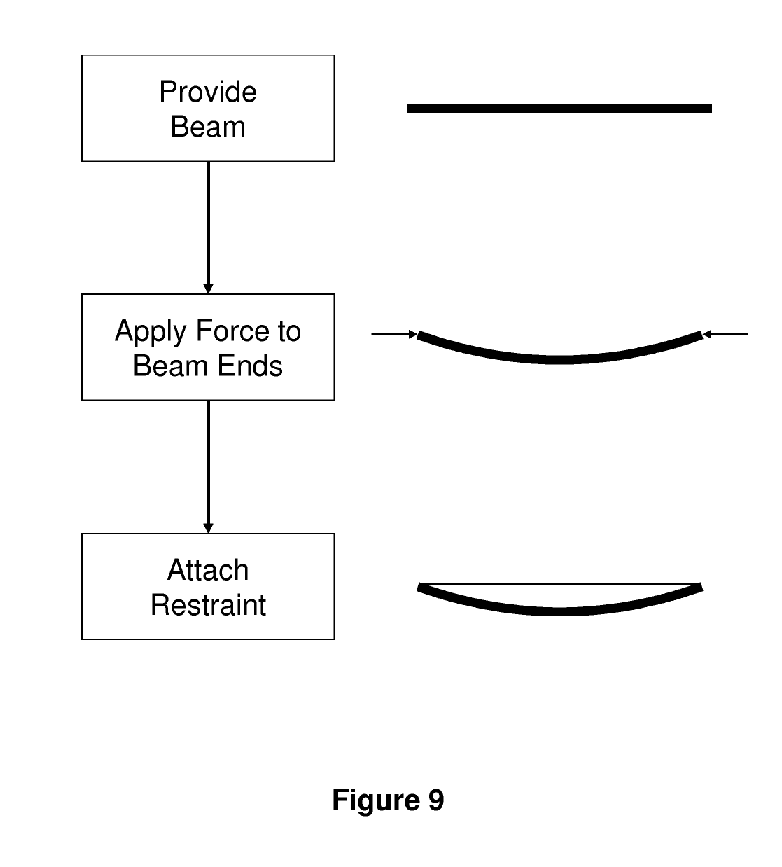

FIG. 9 provides an overview of a first method for forming a parabolic structure. First, a beam having an area moment of inertia which varies along the length of the beam is provided. Next, forces are applied to the ends of the beam to buckle the beam into a parabolic shape. Optionally, one or more restraints are provided to maintain the buckled shape of the beam. In embodiments, the one or more restraints are attached to other parts of the buckled beam, a supporting structure, the ground, or another fixed object.

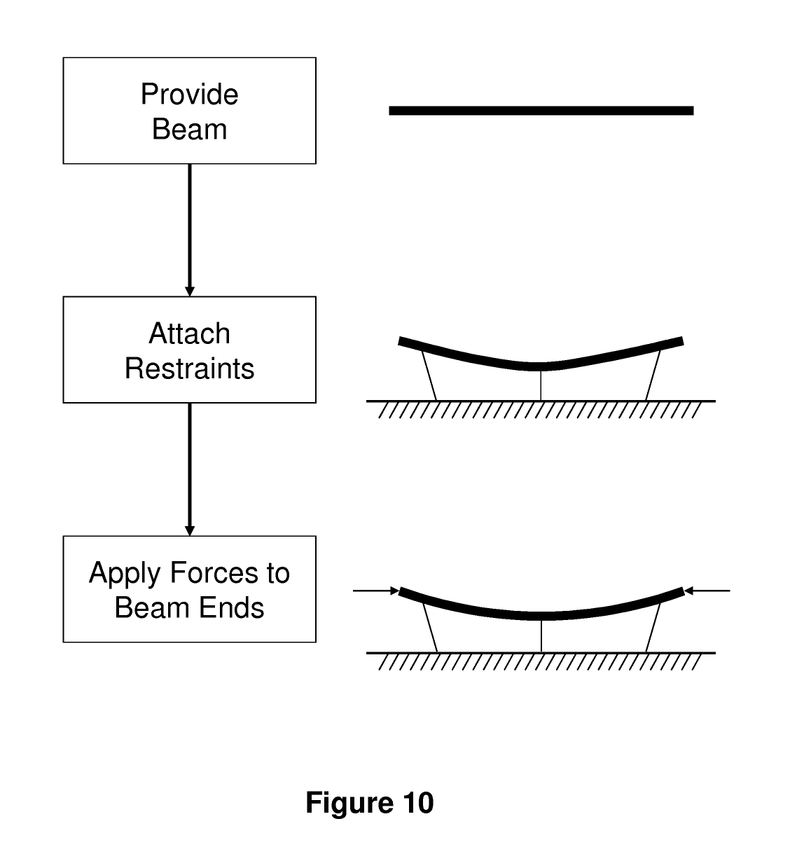

FIG. 10 provides an overview of a second method for forming a parabolic structure. First, a beam having an area moment of inertia which varies along the length of the beam is provided. Next, one or more restraints are attached to the beam. Finally, forces are applied to the ends of the beam to buckle the beam into a parabolic shape. In embodiments, the one or more restraints are attached to other parts of the buckled beam, a supporting structure, the ground, or another fixed object.

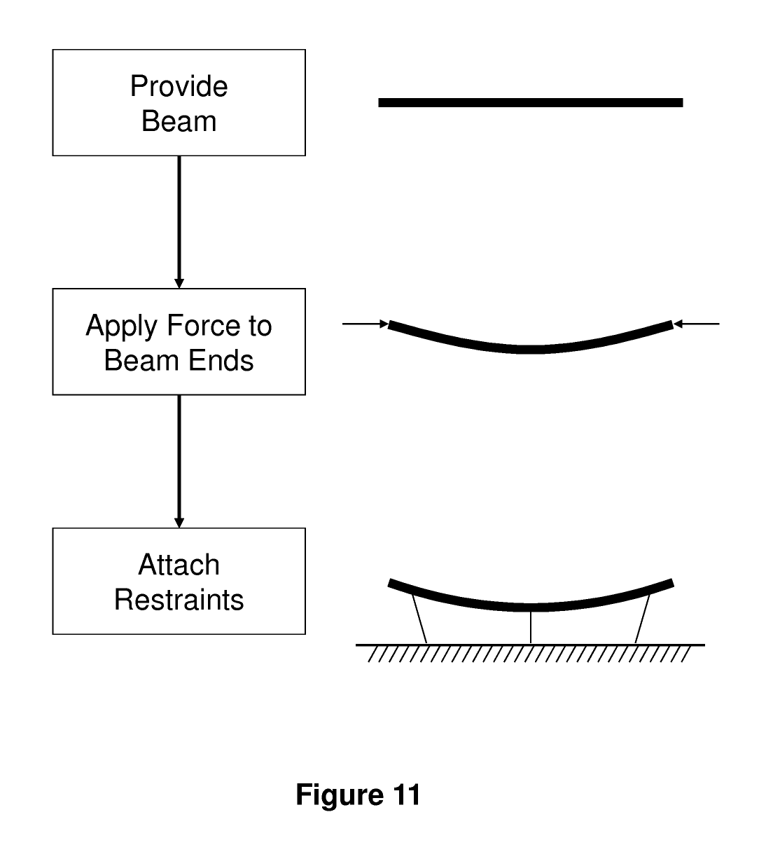

FIG. 11 provides an overview of a third method for forming a parabolic structure. First, a beam having an area moment of inertia which varies along the length of the beam is provided. Next, forces are applied to the ends of the beam to buckle the beam into a parabolic or non-parabolic shape. Finally, one or more restraints are attached to the beam to force the buckled beam into a parabolic shape. In embodiments, the one or more restraints are attached to other parts of the buckled beam, a supporting structure, the ground, or another fixed object.

### REFERENCES

WO 80/02604

U.S. 2004/0074180

U.S. 2004/0074202

U.S. 2005/0050836

U.S. 2005/0252153

U.S. 2008/0226846

U.S. Pat. No. 4,571,812

U.S. Pat. No. 5,398,462

U.S. Pat. No. 6,349,521

U.S. Pat. No. 6,740,381

U.S. Pat. No. 7,163,241

U.S. Pat. No. 7,393,577

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of materials are intended to be exemplary, as it is known that one of ordinary skill in the art can name the same material differently. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An optical structure comprising a buckled beam having an optical shape, wherein an area moment of inertia of the beam varies along a length of the beam.

2. The structure of claim 1, wherein the area moment of inertia is selected so as to give the beam the optical shape when buckled.

3. The structure of claim 1, wherein the area moment of inertia is an area moment of inertia perpendicular to a longitudinal axis of the beam.

4. The structure of claim 1, wherein a cross sectional area of the beam varies along the length of the beam.

5. The structure of claim 4, wherein the cross sectional area of the beam is selected so as to give the beam the optical shape when buckled.

6. The structure of claim 1, wherein a material property of the beam varies along the length of the beam.

7. The structure of claim 6, wherein the material property is selected from the group consisting of density, material composition, crystal structure, structural composition, reticulation, extent of cross-linking, elastic modulus and any combination of these.

8. The structure of claim 6, wherein the material property of the beam is selected so as to give the beam the optical shape when buckled.

9. The structure of claim 1, wherein the beam comprises a hollow tube having a thickness which varies along the length of the beam.

10. The structure of claim 1, wherein the beam comprises a hollow tube which has a varying deformation along the length of the beam.

11. The structure of claim 1, wherein the beam comprises a column having a plurality of segments.

12. The structure of claim 11, wherein the area moments of inertia of adjacent segments are different.

13. The structure of claim 1, further comprising one or more restraints attached to the buckled beam to maintain the optical shape of the beam.

14. The structure of claim 13, wherein at least one of the restraints is attached to a supporting structure.

15. The structure of claim 1, further comprising a reflective sheet attached to the beam.

16. The structure of claim 15, wherein the beam and the reflective sheet comprise a unitary body.

17. The structure of claim 15, wherein the reflective sheet has the optical shape.

18. The structure of claim 1, wherein the optical shape is a non-sinusoidal shape.

19. The structure of claim 1, wherein the optical shape is an arc shape.

20. The structure of claim 1, wherein the optical shape is a focusing shape.

21. The structure of claim 1, wherein the optical shape is a parabolic shape.

22. An optical structure comprising a buckled beam and one or more restraints attached to the buckled beam, wherein the buckled beam has an optical shape.

23. The structure of claim 22, wherein at least one of the restraints is further attached to a supporting structure.

24. The structure of claim 22, wherein the position of the restraints is selected so as to give the beam the optical shape when buckled.

25. The structure of claim 22, wherein at least one of the restraints provides a force to the beam selected so as to give the beam the optical shape when buckled.

26. The structure of claim 22, further comprising a reflective sheet attached to the beam.

27. The structure of claim 26, wherein the beam and the reflective sheet comprise a unitary body.

28. The structure of claim 26, wherein the reflective sheet has the optical shape.

29. The structure of claim 22, wherein the optical shape is a non-sinusoidal shape.

30. The structure of claim 22, wherein the optical shape is an arc shape.

31. The structure of claim 22, wherein the optical shape is a focusing shape.

32. The structure of claim 22, wherein the optical shape is a parabolic shape.

33. A method for forming an optical structure, the method comprising the steps of:
providing a beam having two ends and an area moment of inertia which varies along a length of the beam; and
applying a force to one or both ends of the beam to buckle the beam into an optical shape.

34. The method of claim 33, wherein the area moment of inertia is an area moment of inertia perpendicular a longitudinal axis of the beam.

35. The method claim 33, wherein a cross sectional area of the beam varies along the length of the beam.

36. The method of claim 33, wherein a material property of the beam varies along the length of the beam.

37. The method of claim 36, wherein the material property is selected from the group consisting of density, material composition, crystal structure, structural composition, reticulation, extent of cross-linking, elastic modulus and any combination of these.

38. The method of claim 33, further comprising the step of attaching one or more restraints to the beam.

39. The method of claim 38, wherein the one or more restraints maintain the optical shape of the beam.

40. The method of claim 38, wherein the one or more restraints give the beam the optical shape when buckled.

41. The method of claim 33, wherein the optical shape is a non-sinusoidal shape.

42. The method of claim 33, wherein the optical shape is an arc shape.

43. The method of claim 33, wherein the optical shape is a focusing shape.

44. The method of claim 33, wherein the optical shape is a parabolic shape.

45. A method for forming an optical structure, the method comprising the steps of:
providing a beam having two ends;
attaching one or more restraints to the beam; and
applying a force to one or both ends of the beam to buckle the beam.

46. The method of claim 45, wherein the applying step buckles the beam into an optical shape.

47. The method of claim 45, wherein the attaching step forces the beam into an optical shape.

48. The method of claim 46, wherein the optical shape is a non-sinusoidal shape.

49. The method of claim 46, wherein the optical shape is an arc shape.

50. The method of claim 46, wherein the optical shape is a focusing shape.

51. The method of claim 46, wherein the optical shape is a parabolic shape.
